(19) United States
(12) Patent Application Publication
(10) Pub. No.: US 2006/0174481 A1
(43) Pub. Date: Aug. 10, 2006

(54) Electrical connector and method for producing the same

(76) Inventor: Ted Ju, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/052,517

(22) Filed: Feb. 8, 2005

(51) Int. Cl. H01R 43/16

(52) U.S. Cl. 29/874; 29/884; 29/887; 29/883

(57) ABSTRACT

An electrical connector and a method for producing the same are described. The electrical connector has an insulative housing and a plurality of metallic wires. The insulative housing has a plurality of slots formed therein, and the slots are defined with a width less than that of the metallic wire. The metallic wires are set into the slots and further are folded. Each of the metallic wires has a contact portion protruding out of a surface of the insulative housing for electrically connecting the electrical component.

### BACKGROUND OF THE INVENTION

1. Field of the Invention

The present invention relates to an electrical connector and a method for producing the same.

2. Description of Related Art

The conventional electrical connector generally includes an insulative housing and a plurality of contacts received in respective channels, which are formed in lateral walls of the insulative housing. The insulative housing further includes a plurality of engaging slots formed in a bottom thereof and communicating with the channels. Pluralities of engaging portions disposed on the contacts are pressed into the engaging slots to mate with the insulative housing. Such a connector is not cheap and is difficult to manufacture and assemble.

### SUMMARY OF THE INVENTION

An electrical connector and a method for producing the same are provided for cheap, easy manufacture and simple assembly.

An electrical connector includes an insulative housing and a plurality of metallic wires. The insulative housing has a plurality of slots formed therein, and the slots are defined with a width less than that of the metallic wire. The metallic wires are set into the slots and further are folded. Each of the metallic wires has a contact portion protruding out of a surface of the insulative housing for electrically connecting the electrical component.

A method for producing the electrical connector includes the following steps. (1) An insulative housing having a plurality of slots and a plurality of metallic wires is provided. The slots are defined with a width less than that of the metallic wire. (2) The mold and the insulative housing are pressed together to fold and embed simultaneously the metallic wires into the slots thereof. Each of the metallic wires has a contact portion protruding out of a surface of the insulative housing.

To provide a further understanding of the invention, the following detailed description illustrates embodiments and examples of the invention. Examples of the more important features of the invention have thus been summarized rather broadly in order that the detailed description thereof that follows may be better understood, and in order that the contributions to the art may be appreciated. There are, of course, additional features of the invention that will be described hereinafter which will form- the subject of the claims appended hereto.

### BRIEF DESCRIPTION OF THE DRAWINGS

These and other features, aspects, and advantages of the present invention will become better understood with regard to the following description, appended claims, and accompanying drawings, where:

FIG. 1 is a perspective view of an electrical connector according to the present invention;

FIG. 2 is a perspective view according to the present invention during assembly of an insulative housing with metallic wires;

FIG. 3 is a decomposition view of the electrical connector, an upper mold and a lower mold according to the present invention;

FIG. 4 is a perspective view of the electrical connector according to the present invention;

FIG. 5 is a perspective view of the electrical connector when the metallic wires are cut;

FIG. 6 is a decomposition view of the of the electrical connector, an upper mold and a lower mold according to another embodiment of the present invention;

FIG. 7 is a perspective view according to FIG. 6; and

FIG. 8 is a perspective view in accordance with another embodiment of the electrical connector according to the present invention.

### DETAILED DESCRIPTION OF PREFERRED EMBODIMENTS

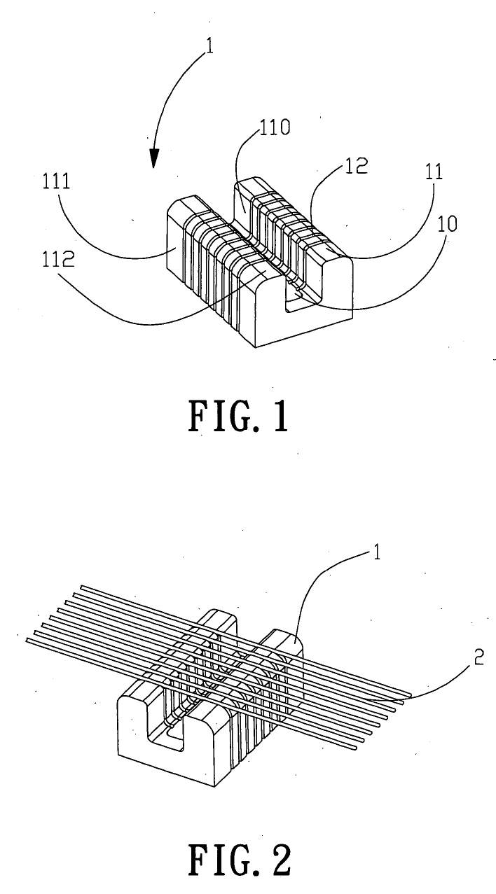

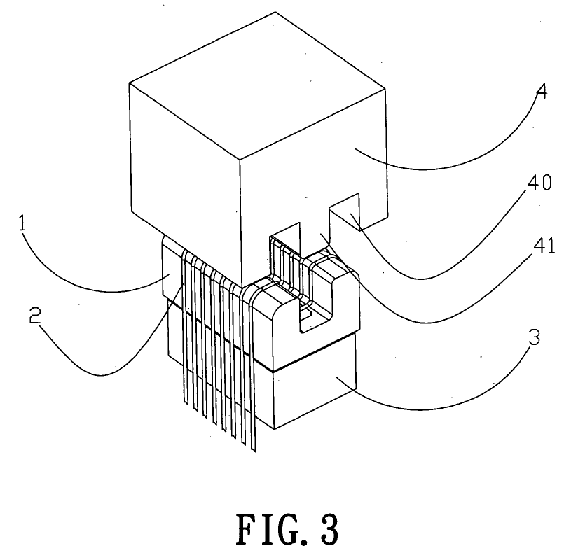

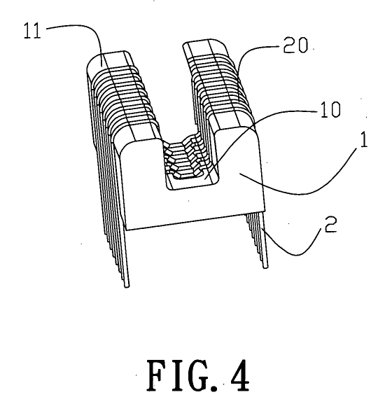

With respects to FIGS. 1 to 4, an electrical connector according to the present invention includes an insulative housing 1 and a plurality of metallic wires 2. The insulative housing 1 has a concave 10 formed in a middle thereof, two lateral sidewalls 11 adjacent to the concave 10, and a plurality of slots 12 formed continually over an exterior surface 111, an interior surface 110 and a top surface 112 of the sidewalls 11. The metallic wires .2 are set into the slots 12 of the insulative housing 1, respectively, and further folded. The slots 12 are defined with a width less than that of the metallic wires .2, in order to secure the metallic wires 2 in the insulative housing 1. Each of the metallic wires 2 has contact portion 20 protruding out of a surface of the insulative housing 1 for electrical connection. Two ends of each metallic wire 2 can be kept with proper length for forming a cord.

A method for producing the electrical connector includes the following steps. (1) An insulative housing 1 and a plurality of metallic wires 2 are provided. The insulative housing 1 has a concave 10 formed in a middle thereof, two lateral sidewalls 11 disposed adjacent to the concave 10, and a plurality of slots 12 formed continually over an exterior surface 111, an interior surface 110 and a top surface 112 of the sidewalls 11. The metallic wires 2 are provided with proper length and further placed over the slots 12 on the top surface 112 of the lateral sidewalls 11. (2) A retaining block 3 and a forming device 4 are provided. The insulative housing 1 and the metallic wires 2 are put on the retaining block 3, which has a width equal to or less than that of the insulative housing 1. The forming device 4 is approximately a rectangular solid, and has two troughs 40 in a lower surface thereof, corresponding to two lateral sidewalls 12 of the insulative housing 1. A projection 41 is disposed between the two troughs 40 and can be received inside the concave 10 of the insulative housing 1. The forming device 4 is pressed downwardly to force the metallic wires 2 to fold and embed simultaneously into the slots 10 of the insulative housing 1. Each of the metallic wires 2 has a contact portion 20 protruding out of the insulative housing 1 to electrically connect another component (not shown). The ends of each metallic wires 2 are substantially parallel to the sidewalls 11.

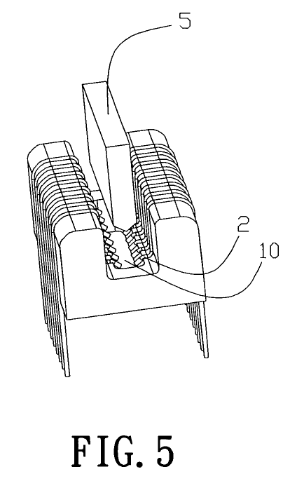

In addition, referring to FIG. 5, the metallic wires 2 in the concave 10 of the insulative housing 1 can be broken by a cutting device 5.

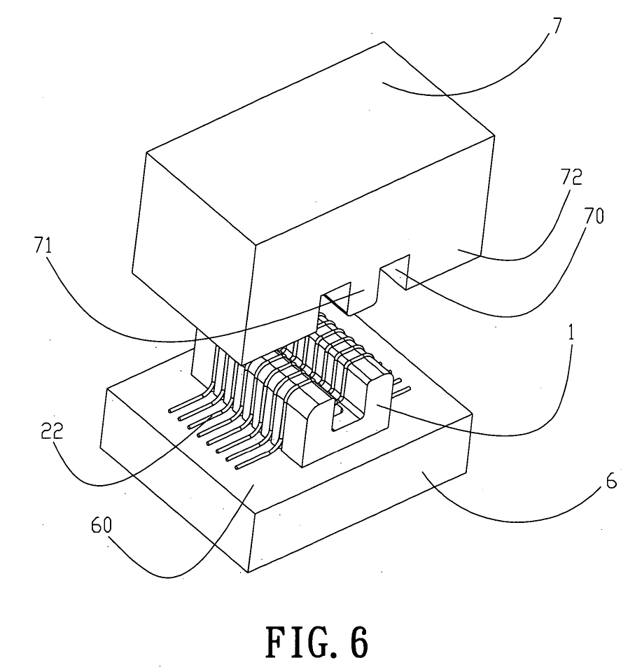

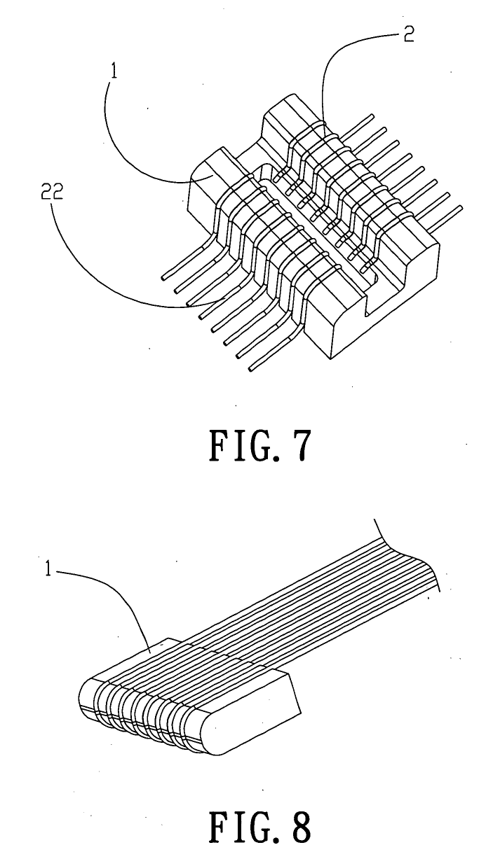

With respect to FIGS. 6 and 7, the insulative housing 1 and the metallic wires 2 can be laid on a lower mold 6, which has a width greater than that of the insulative housing 1. The lower mold 6 has a smooth and clean top surface. An upper mold 7, which has two reception slots 70 formed in a bottom surface thereof and an orientation portion disposed between the two reception slots 70 for placing into the concave 10 of the insulative housing 1, is provided. The upper mold 7 has two suppress portions 72 respectively adjacent to the reception slots 70. Each of the suppress portions 72 has a flat and smooth bottom surface. The upper mold 7 is provided to press the metallic wires 2 again to fold the ends of the wires 2 horizontally. The horizontal ends can be shortened with proper length as solder portions 22, which have a good coplanarity.

The configurations of the upper mold 7 and the lower mold 6 can be changed to suppress respective ends of the metallic wires 2, which are on the same side, and make them horizontal. Alternatively, the vertical ends of the metallic wires 2 at the other side of the insulative housing 1 can be folded along the bottom surface of the insulative housing 1 to combine with the horizontal ends as a cable.

The cross-sectional configuration of the metallic wires can be round, equilaterally polygonal, or flat. Additionally, the metallic wires 2 can be coated with an isolative layer of rubber, futher coated with a conductive layer over the isolative layer for shielding, and then covered with another isolative layer over the conductive layer. In another embodiment, the configuration of the insulative housing 1 can be varied as in FIG. 8.

Thus, by the method according to the present invention, a cheap electrical connector is made with simple steps and easy manufacture.

It should be apparent to those skilled in the art that the above description is only illustrative of specific embodiments and examples of the invention. The invention should therefore cover various modifications and variations made to the herein-described structure and operation of the invention, provided they fall within the scope of the invention as defined in the following appended claims.

1. A method for producing an electrical connector, comprising:
providing an insulative housing with a plurality of slots, and a plurality of metallic wires corresponding to the slots, wherein the slots are defined with a width less than that of the metallic wires; and
suppressing the insulative housing with upper and lower molds, simultaneously folding the metallic wires and embedding the metallic wires into the slots of the insulative housing, wherein each of the metallic wires has a contact portion protruding out of the insulative housing.

2. The method as claimed in claim 1, further including: forming the metallic wires as cables and covered the metallic wires with an isolative layer.

3. The method as claimed in claim 2, further including: providing a conductive layer to cover the isolative layer for shielding, and another isolative layer to cover the conductive layer.

4. The method as claimed in claim 1, further including: providing a respective end of the metallic wires horizontally beside a lower portion of the insulative housing as a solder portion.

5. The method as claimed in claim 1, further including: cutting the metallic wires into two at a predetermined portion of the insulative housing.

6-11. (canceled)
